(19) United States
(12) Patent Application Publication
(10) Pub. No.: US 2004/0020744 A1
(43) Pub. Date: Feb. 5, 2004

(54) Method for preventing fraud in coin-operated or banknote-operated vending machines

(75) Inventor: Herbert Blum, Minden (DE)

Correspondence Address: Norman P. Soloway, HAYES, SOLOWAY P.C., 130 W. Cushing Street, Tucson, AZ, 85701, US

(73) Assignee: HARTING Vending GmbH & Co. KG

(21) Appl. No.: 10/622,154

(22) Filed: Jul. 17, 2003

(30) Foreign Application Priority Data
Aug. 1, 2002 (DE) 102 35 120.1
Aug. 16, 2002 (DE) 102 37 474.0

(51) Int. Cl. G07G 3/00; G07D 7/00

(52) U.S. Cl. 194/202

(57) ABSTRACT

In order to prevent fraud in coin-operated or banknote-operated vending machines, in particular vending machines dispensing goods or services, in which the sale transaction after inserting coins and/or banknotes is initiated when a sufficient credit value is reached and the service is provided, it is proposed to determine the coin or banknote denominations, i.e. the number type, for each numerical procedure, wherein the number types and denomination types that were inserted to reach a specified credit value (K) are determined, the number types and denomination types are added in number type counters (Z), when a predetermined limit criterion is reached a signal (F) is generated, the signal (F) is passed to a logic circuit and a time element (T) is activated that prevents the operation of the vending machine for a duration (Tᵢₙₒₚ)

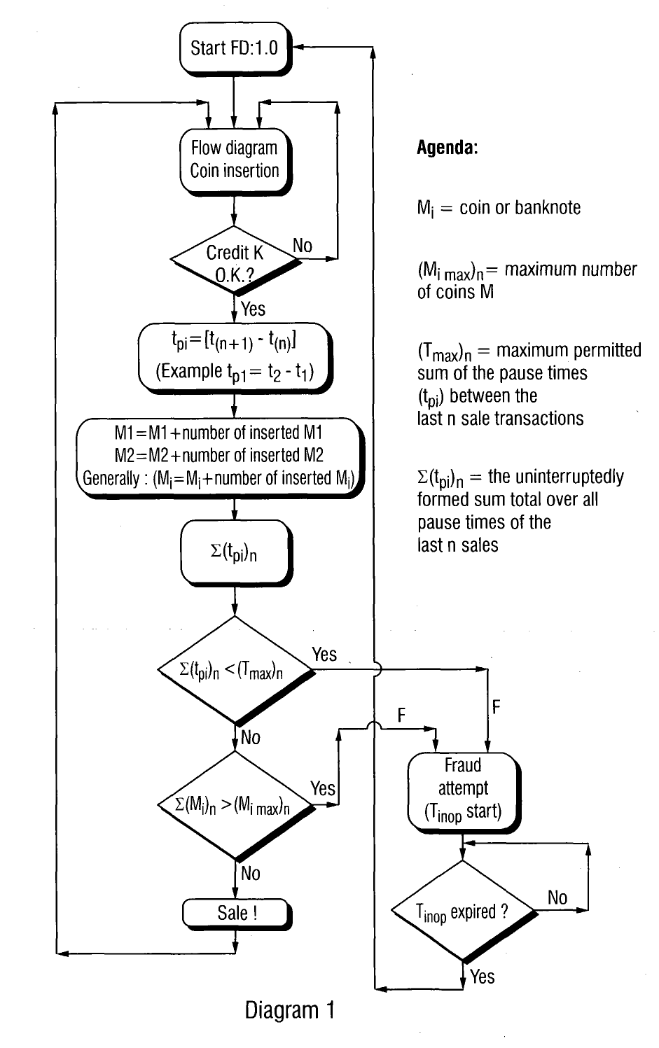

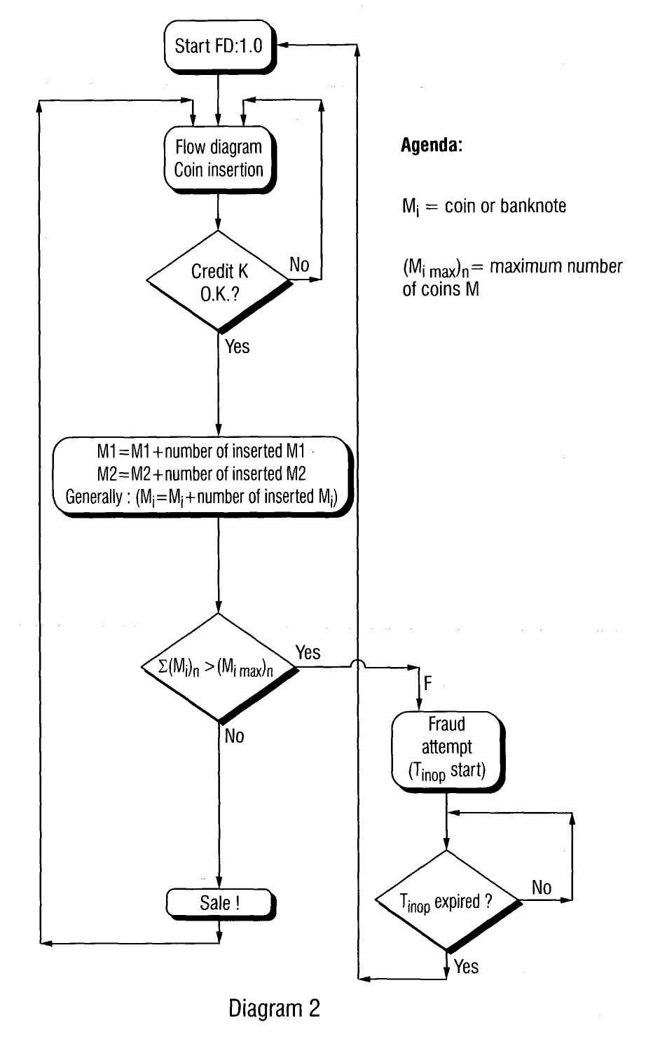

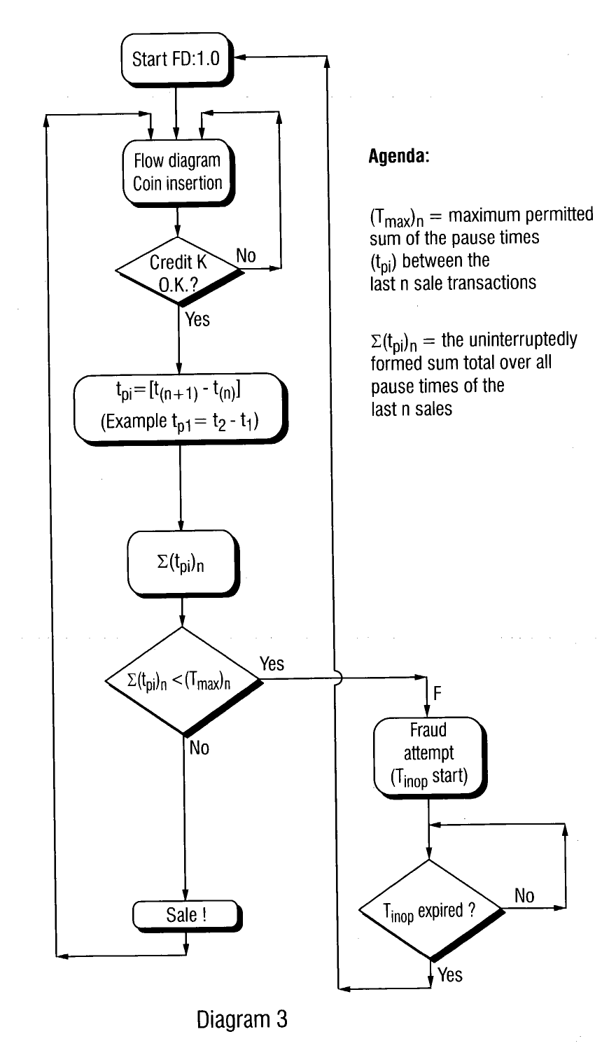

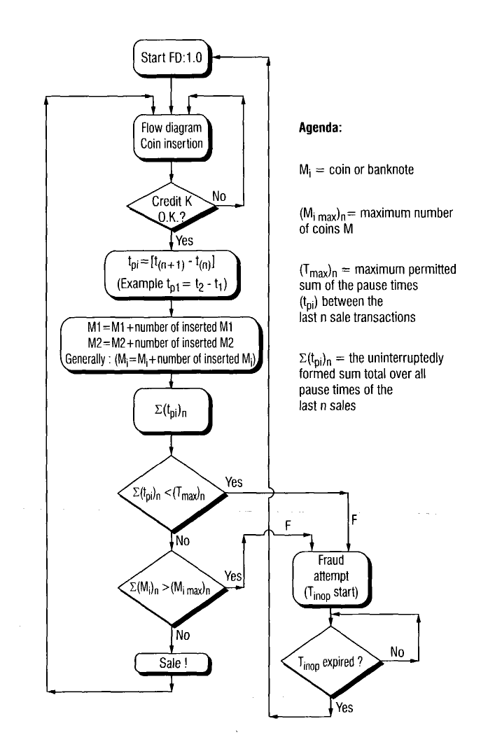

The present invention relates to a method for preventing fraud in coin-operated or banknote-operated vending machines, in particular vending machines dispensing goods or services, in which the sale transaction after inserting coins and/or banknotes is initiated when a sufficient credit value is reached and the said service is provided.

With coin-operated and/or banknote-operated vending machines the dispensing of goods is normally initiated after insertion of the necessary payment, the validity of the payment being checked in a checking device before the procedure to dispense the goods is initiated. In this connection, when money of different denominations is inserted the total value of the inserted money is also determined and the procedure to dispense the goods is initiated only if the total value corresponds to the value of the goods to be dispensed.

Known checking devices in general determine counterfeit money with a high degree of reliability if they are correspondingly sensitively adjusted. In this connection it may however happen that, depending on the adjusted sensitivity, either money that is in fact valid is rejected or counterfeit money is recognised as genuine.

In the past it has been found that counterfeit money that is virtually indistinguishable from genuine money and that can be detected only by extremely sensitively adjusted checking devices has been used with fraudulent intent. This then means that the checking devices that are normally used have to be replaced by new, extremely sensitively adjustable checking devices, wherein a high rejection rate also of genuine money has to be taken into account.

It has been found that in attempts to commit fraud using counterfeit money, as a rule money of a certain value is used time and time again. It may therefore be assumed that an attempt to commit fraud exists if for successive payment transactions money of the same value is always used.

It may furthermore be assumed that an attempt to commit fraud likewise exists if certain coin or banknote values are used in an excessive (abnormal) frequency.

The object of the present invention is to detect attempts to commit fraud in coin-operated or banknote-operated vending machines, in particular vending machines dispensing goods or services, by counterfeit money that is used in successive sale transactions or numerical procedures, and to initiate measures to limit the damage and thereby make the operation of such vending machines more secure.

This object is achieved according to the invention in that the coin or banknote denomination, i.e. the number type, is determined for each numerical procedure, wherein the number types or denomination types that were inserted to achieve a specified credit value are determined, that the said number types or denomination types are added in number type counters, that a signal is generated when a preset limit criterion is reached, and that the signal is passed to a logic circuit and a time element is activated that prevents the operation of the vending machine for a specified duration.

Advantageous modifications of the invention are disclosed in claims 2 and 3.

A further object of the invention is achieved in that the coin or banknote denomination, i.e. the number type, is determined for each numerical procedure, wherein the types of coins or banknotes that were inserted to achieve a specified credit value are determined, that the frequency with which identical coins or banknotes were inserted in a plurality of sale transactions is determined, that a signal is generated when a preset limit criterion is reached, and that the signal is passed to a logic circuit and a time element is activated that, prevents the operation of the vending machine for a specified duration.

Further advantageous modifications of the invention are disclosed in claims 5 to 15.

The advantages achieved with the invention consist in particular in the fact that, by determining the number type, i.e. by detecting which denominations of coins or banknotes were used for a sale transaction, or which coin or banknote values were used excessively frequently, it can be detected whether an attempt to commit fraud exists. If so, measures to prevent fraud can then be initiated.

These measures may consist in that first of all the vending machine or the payment acceptance device is rendered inoperative for a certain time, that a camera is activated that photographs the user of the vending machine, and that an “emergency notification” to the vending machine attendant is triggered by radio or GSM/telephone.

The invention is described in more detail hereinafter.

In order to obtain a desired article from the vending machine, the user as a rule first of all selects the article and then inserts coins or banknotes (money) into the vending machine. The validity of the inserted money is then checked in a coin or banknote checking device. If the money is recognised as genuine, the individual values are added in order to determine whether the purchase price credit value K (purchase price) of the selected article is achieved.

In addition the number type, i.e. the combination of the coin and/or banknote denominations used to reach the credit value K is determined. These number types are added up in number type counters Z so that it can be determined what number types were used. The following for example is understood as a number type: insertion of three 1 [symbol] coins, or insertion of two 1 [symbol] coins and two 50 cent coins to achieve a credit value.

In this way it can be determined whether the current number type ZA₍ₙ₎ differs from the last used number type ZA₍ₙ₋ᵢ₎.

If the current number type corresponds to the last used number type, a number type counter Z is increased by the value 1 with each identical numerical procedure (sale transaction).

If a number type is used that differs from the preceding number type, the counter first of all remains at the last value in order possibly to filter out an interrupted attempt at fraud.

As long as the number type counter Z has an initial value that lies below a preadjustable limiting value Zₓ, the sale transaction is initiated when the purchase price of the selected article is reached and the article chosen by the user is dispensed.

As soon as the number type counter Z reaches a preadjustable value Zₓ, it may be deduced from this that fraudulent numerical procedures are taking place.

If for example the same number type ZA was used five times in succession, it may be assumed that there is an attempt to commit fraud.

An attempt to commit fraud may likewise be assumed if for example in the last ten sales the preset limiting value of the coin selection of a coin M_{i max} is reached.

The initial values Zₓ of the number type counters Z are therefore compared with a limit criterion (par example the value five) and if the limit criterion is reached a fault signal F is generated. It is preferably envisaged that the limit criterion can be adjusted by the vending machine operator.

A fault signal F is then generated that triggers the termination of the sale transaction.

For this purpose the fault signal F (detected attempt to commit fraud) is passed to an evaluation logic device.

The evaluation logic device now triggers various sequences: first of all a time element T is activated that renders the payment acceptance device of the vending machine inoperative for a certain time Tᵢₙₒₚ so that no further attempts to commit fraud can take place. It may in this connection be envisaged that only the acceptance of the payment having the value of the previously attempted fraud is prevented. It may preferably be envisaged that the time Tᵢₙₒₚ for which the payment acceptance device is rendered inoperative can be adjusted. After expiry of the time Tᵢₙₒₚ the money type counter Z (sale transaction counter) is reset to 0.

It may if necessary also be envisaged that the time element T has an incremental function, whereby in the event of successive fault signals (attempts to commit fraud) the time is in each case extended until, after n attempts to commit fraud, the vending machine is rendered completely inoperative.

The time element T may optionally also comprise a time function TF₍ₚ₎ whose behaviour (duration, nature and manner) can be characterised by parameters.

It may be envisaged that the evaluation logic device activates an alarm signal in the event of a fault (detected attempt to commit fraud).

It may furthermore be envisaged that the evaluation logic device activates a photographic medium, preferably a digital camera, so that the user is photographed.

It may in addition be envisaged that the evaluation logic device triggers an emergency notification that is passed on by radio or GSM/telephone to a fault-clearance service, and if necessary to a vending machine attendant.

In a further modification of the invention it may be envisaged that the number type counter Z carries out a detailed evaluation so as to determine the frequency with which identical coins or banknotes were used for the numerical procedures. If the frequency exceeds a predetermined limit criterion, a fault signal F is likewise generated and the operation of the vending machine is prevented as described hereinbefore.

In yet a further modification of the invention it may be envisaged that the time Tᵥ between two successive sale transactions is measured. With very short times, i.e. sale transactions immediately following one another, it may be assumed that an attempt to commit fraud exists. The time Tᵥ is therefore compared with a preset limiting value T_{V-V}, and if Tᵥ is below this limiting value the fault signal F is generated and the operation of the vending machine is prevented as described hereinbefore.

It may be envisaged that the sum Tᵥₛ of the times Tᵥ for a plurality of successive sale transactions is determined and is compared to a limiting value (Tₘₐₓ)ₙ. If the sum Tᵥₛ lies below this limiting value, the fault signal F is generated and the operation of the vending machine is prevented as described hereinbefore. Preferably the limiting values (times T_{V-V} and/or (Tₘₐₓ)ₙ ) can be adjusted by the vending machine operator (installer). It may however also be envisaged that the maximum limiting values are determined dynamically and independently. To this end the times Tᵥ are then considered for a number of sale transactions and an average “normal” time is determined.

An incremental value ΔM, ΔT is added to this value and the resultant value is used as a theoretical limiting value M_{i max} or Tₘₐₓ. In this connection M_{i max} denotes the maximum number of coins M of each individual value within the uninterruptedly slidly mean average considered last payment transactions and Tₘₐₓ denotes the maximal permitted sum of the pause times Tᵥₛ between the last sale transactions.

The vending machines are normally provided with a refund button, whereby the previously inserted coin or banknote payment can be returned, though the originally inserted coins or banknotes are not always returned, but instead an equivalent amount corresponding to the inserted money is counted out from a separate source storage. In order to prevent “invalid” money first of all being inserted and valid money then being returned by means of the refund button, it may be envisaged that the number of successively executed refund procedures is counted. If the determined number exceeds a normal limiting value, which in turn may also preferably be adjusted by the vending machine operator/installer, then the fault signal F is generated and the operation of the vending machine is prevented as described in more detail above.

The sequence of the described method before is illustrated by way of example in three sequence plans, the program sequence plans being executed corresponding to DIN 66001, and is described in more detail hereinafter with the aid of the diagrams, in which:

Diagram 1 is a flow diagram for the overall sequence,

Diagram 2 is a flow diagram for the coin checking sequence, and

Diagram 3 is a flow diagram for the time checking sequence.

The overall sequence of the method for preventing the misuse of coin-operated or banknote-operated vending machines is illustrated in Diagram 1. The functionality of the equipment is given with the starting point FD 1.0. After insertion of an arbitrary number Aᵥ of coins or banknotes it is first of all checked whether the necessary credit K has been reached.

If the credit is reached the pause time tₚᵢ between the end of the last numerical or credit procedure and the start of the next numerical or credit procedure is established and compared with an uninterruptedly determined valueΣ (tₚᵢ)ₙ obtained from a number of various sale transaction procedures.

The coins are then checked as regards their frequency of insertion and their value within the uninterruptedly considered last payment transactions.

If the pause time tₚᵢ determined in the branching remains within the scope of the uninterruptedly calculated values between two sale transactions, and if at the same time it is determined that the sum total of the coins of the same values is less than a predetermined value, then the sale is authorised.

If it is found in the determination that the pause times tₚᵢ between the sales are less than a predetermined limiting value resulting from the uninterrupted summation of the pause times, then it is assumed that an attempt to commit fraud has been made and the vending machine is rendered inoperative for a certain time.

Likewise, if it is found that the number of identical coins Mᵢ exceeds a certain predetermined value, then again it is assumed that an attempt to commit fraud has been made and the vending machine is rendered inoperative for a certain time.

After the inoperative time Tᵢₙₒₚ has expired the vending machine is automatically restored to operation.

Diagram 2 shows the testing sequence of the method for determining the frequency of insertion of identical coins.

The functionality of the equipment is given with the starting point FD 1.0. After inserting an arbitrary number Aᵥ of coins or banknotes it is first of all checked whether the necessary credit K has been reached.

It is then checked how frequently the various types of coins Mᵢ have been inserted and whether the maximum number M_{i max} of coins of each value is within the uninterruptedly considered last payment transactions.

If the maximum predetermined number M_{i max} of coins of the same value is exceeded it is assumed that an attempt to commit fraud has been made and the vending machine is for example rendered inoperative for a specified time Tᵢₙₒₚ, failing which the selected article is dispensed.

Diagram 3 shows the testing sequence of the method for determining the permitted pause times between the pause times of the last sale transactions. The functionality of the equipment is given with the starting point FD 1.0.

After inserting an arbitrary number Aᵥ of coins or banknotes it is first of all checked whether the necessary credit K has been reached.

The pause time tₚᵢ between the current credit transaction and the preceding credit transaction is then determined and added to the uninterruptedly determined and already stored sum of a specified number of pause times Σ (tₚᵢ)ₙ, and compared to the maximum preadjusted and permitted limiting value Tₘₐₓ.

In this connection in each case a specified number of pause times t_{p i} is summated as in a shift register, and when a new pause time is determined the first measured pause time is discarded (first in—first out).

If the current sale transaction times are found to be substantially shortened over several sales, then it is assumed that an attempt to commit fraud has been made and for example the vending machine is rendered inoperative for a certain time Tᵢₙₒₚ, failing which the selected article is dispensed.

After the inoperative time has expired T_{expired} the vending machine is independently restored to operation.

### Reference Numeral List

| | |
|---|---|
| K = | Credit, (sale price) |
| Z = | Number type counter |
| Aᵥ = | arbitrary Number of sale transactions |
| ZA(n) = | current number type |
| Z(n − 1) = | last number type |
| Zₓ = | preadjustable limit value of the number type counter, |
| F = | Signal, fault signal |
| T = | Time element |
| tₚᵢ = | timing of pauses between successive sale transactions |
| T_{V} = | Time between two successive sale transactions |
| T_{V S} = | Sum of the times T_{V} of several successive sale transactions |
| T_{V-V} = | Preset time for successive sale transactions |
| TF_{(P) i} = | Time function of the time element T, preadjustable |
| (Tₘₐₓ)ₙ = | maximum value of the sale transactions T_{VS} |
| T_{expired} = | expired time |
| Tᵢₙₒₚ = | inoperative time |
| Mᵢ = | Value of type of coin, banknote M1, M2, . . . Mi max |
| M_{i max} = | Maximum limiting value of a type of coin/banknote |
| Δ M = | Incremental(factor) value of the number of a type |
| | of coin/banknote |
| Δ T = | Incremental(factor) value for the overall time ΣT_{V} |

1. Method for preventing fraud in coin-operated or banknote-operated vending machines, in particular vending machines dispensing goods or services, in which the sale transaction after inserting coins and/or banknotes is initiated when a sufficient credit value is reached and the said service is provided, characterised in that the denominations of the coins or banknotes i.e. the number type, is determined for each numerical procedure, wherein the number types or denomination types that were inserted until a specified credit value (K) was reached are determined, that the number types or denomination types are added in number type counters (Z),
that when a predetermined limit criterion is reached a signal (F) is generated, and
that the signal (F) is passed to a logic circuit and a time element (T) is activated that prevents the operation of the vending machine for a duration (Tᵢₙₒₚ).

2. Method according to claim 1, characterised in that the initial value (Zₓ) of the number type counter in which the signal (F) is generated can be adjusted.

3. Method according to claim 1 or 2, characterised in that with successive numerical procedures involving different denominations, i.e. with different number types, the number type counter (Z) is reset.

4. Method for preventing fraud in coin-operated or banknote-operated vending machines, in particular vending machines dispensing goods or services, in which the sale transaction after inserting coins and/or banknotes is initiated when a sufficient credit value is reached and the said service is provided, characterised in that
the coin or banknote denominations, i.e. the number type, is determined for each numerical procedure, wherein the types of coins or banknotes that were inserted until a specified credit value (K) was reached are determined,
that the frequency with which identical coins or banknotes were inserted in the case of a plurality of sale transactions is determined,
that when a preset limit criterion is reached a signal (F) is generated, and that the signal (F) is passed to a logic circuit and a time element (T) is activated that prevents the operation of the vending machine for a duration (Tᵢₙₒₚ).

5. Method according to claim 4, characterised in that the time element (T) comprises a time function (TF₍ₚ₎ᵢ) whose behaviour (duration, nature and manner) can be described by parameters.

6. Method according to one of the preceding claims, characterised in that the logic circuit, i.e. the time element (T), acts in such a way on a coin or banknote checking device that the acceptance of coins or banknotes of this value is prevented for a duration (Tᵢₙₒₚ).

7. Method according to one of the preceding claims, characterised in that the duration (Tᵢₙₒₚ) of the time element (T) can be adjusted.

8. Method according to one of the preceding claims, characterised in that the duration (Tᵢₙₒₚ) of the time element (T) has an incremental function, wherein the time in the case of successive attempts to commit fraud is in each case extended.

9. Method according to one or more of the preceding claims, characterised in that the time (Tᵥ) between two successive sale transactions is measured and
that if a preset time (T_{V-V}) is not reached in one or a predetermined number (Aᵥ) of sale transactions (Σ Tᵥ), a signal (F) is generated that prevents the operation of the vending machine and consequently the sales for a duration (Tᵢₙₒₚ).

10. Method according to one or more of the preceding claims, characterised in that the times (Tᵥ) between two successive sale transactions is measured, that in the case of several successive sale transactions their total time (Tᵥₛ) is determined,
that the time (Tᵥₛ) is compared to a limiting value ((Tₘₐₓ)ₙ), and
that if this limiting value is not reached a signal (F) is generated that prevents the operation of the vending machine and consequently the sales for a duration (Tᵢₙₒₚ).

11. Method according to claim 9 or 10, characterised in that the time (T_{V-V}) and/or ((Tₘₐₓ)ₙ) can be adjusted.

12. Method according to one or more of the preceding claims, characterised in that the maximum limiting values (M_{i max}) as well as (Tₘₐₓ) are determined dynamically and independently via a number (Aᵥ) of considered sale transactions and the future limiting theoretical value is determined via an incremental value (ΔM, ΔT).

13. Method according to one or more of the preceding claims, characterised in that the number of refund attempts over several successive sale transactions is determined, and that if a preadjustable limiting value is reached then the fault signal (F) is generated.

14. Method according to one or more of the preceding claims, characterised in that a circuit arrangement is activated through the signal (F) by means of which an emergency notification/interference notification is initiated by radio or GSM/telephone.

15. Method according to one or more of the preceding claims, characterised in that a photographic medium, preferably a digital camera, is activated by the signal (F), by means of which the user of the vending machine is recorded.
